(19) United States
(12) Patent Application Publication
(10) Pub. No.: US 2026/0280888 A1
(43) Pub. Date: Sep. 17, 2026

(54) ZERO-TRUST MULTI-AGENT PLATFORM FOR TRUSTED AI CODE GOVERNANCE

(71) Applicant: George William Bickerstaff, III, Greenwich, CT (US)

(72) Inventor: George William Bickerstaff, III, Greenwich, CT (US)

(21) Appl. No.: 19/676,989

(22) Filed: May 14, 2026

(51) Int. Cl. H04L 9/32

(52) U.S. Cl. CPC H04L 9/3234

(57) ABSTRACT

A zero-trust multi-agent orchestration platform for trusted artificial-intelligence code generation and governance executes its security-critical agent operations, orchestration, and attestation validation within hardware Trusted Execution Environments (TEEs), with external smart-contract execution and external-system interactions occurring over cryptographically attested channels whose receipts are bound to a continuous attestation chain. An orchestration engine dynamically spawns specialized agents bound by self-sovereign identities to hardware-rooted TEE measurements. An economic incentive engine issues tokenized or non-tokenized rewards or applies slashing via smart contracts according to a multi-factor contribution score, with issuance and slashing gated on valid TEE attestation. Inter-agent collaboration occurs over post-quantum-secure attested channels with zero-knowledge proofs. A tamper-evident provenance ledger records all events as a closed-loop attestation-economic-provenance-evidence state machine and produces audit-ready cryptographic evidence bundles for regulatory submission, third-party audit, and insurance claims defense.

### CROSS-REFERENCE TO RELATED APPLICATIONS

This application claims priority benefit under 35 U.S.C. § 119(e) to U.S. Provisional Patent Application No. 64/054,341, filed Apr. 30, 2026, assigned Confirmation No. 7565 and Patent Center No. 75737056, naming George William Bickerstaff, III as the sole inventor, the entire contents of which are incorporated herein by reference. Applicant reserves the right to file one or more continuation, continuation-in-part, divisional, and foreign counterpart applications based on the present disclosure.

### STATEMENT REGARDING FEDERALLY SPONSORED RESEARCH OR DEVELOPMENT

Not applicable.

### REFERENCE TO SEQUENCE LISTING, TABLE, OR COMPUTER PROGRAM LISTING

Not applicable.

### FIELD OF THE INVENTION

The present invention relates to systems, methods, and non-transitory computer-readable media for autonomous, hardware-anchored, zero-trust multi-agent orchestration of artificial-intelligence agents for trusted code generation, verification, and governance. More particularly, the invention relates to the integration, depicted across FIGS. 1-5 and their sub-figures, of trusted execution environments, self-sovereign agent identities, tokenized economic incentives delivered and enforced by smart contracts, post-quantum-secure verifiable collaboration, and a tamper-evident provenance ledger producing audit-ready cryptographic evidence suitable for regulatory submission, third-party audit, insurance claims defense, and litigation discovery.

### BACKGROUND OF THE INVENTION

Autonomous multi-agent artificial-intelligence systems have advanced rapidly in code generation, verification, and decision-making applications across regulated industries including healthcare, financial services, defense, and enterprise software. As deployment of such systems expands into safety-critical and regulator-supervised domains, four technical inadequacies have become acute: (i) absence of hardware-rooted trust binding each agent's identity to a verifiable execution context; (ii) absence of economic alignment mechanisms that reward verified contributions and penalize misbehavior at the speed of agent operation; (iii) absence of regulator-grade audit evidence linking agent contributions to final code or model artifacts in a tamper-evident chain; and (iv) absence of post-quantum cryptographic protection against the medium-term threat of cryptographically relevant quantum computers.

Prior approaches address these inadequacies only in isolation. Some systems provide hardware-rooted attestation for confidential computing workloads but lack any economic incentive layer, smart-contract enforcement, or persistent provenance. Other systems provide tokenized incentives for decentralized computation but operate outside trusted execution environments, leaving model weights, prompts, and inference state exposed to privileged software and infrastructure operators. Still other systems provide provenance ledgers for software artifacts but record only post-hoc summaries rather than a continuous attestation chain linking every agent action, collaboration, and economic transaction. Applicant is unaware of any prior system that integrates hardware-rooted multi-agent orchestration, smart-contract-enforced economic incentives and slashing, post-quantum-secure verifiable collaboration, and audit-ready cryptographic evidence generation in a single platform.

Among prior approaches relevant to the present disclosure, three categories are noted. In the first category, confidential-computing platforms employing trusted execution environments provide hardware-rooted attestation for individual workloads but do not integrate economic incentive layers, smart-contract enforcement, or persistent cryptographic provenance bound to the attestation chain. In the second category, decentralized-compute platforms offering tokenized incentives for off-chain computation typically operate outside trusted execution environments, leaving model weights, prompts, and inference state exposed to privileged software and infrastructure operators, and do not produce audit-ready cryptographic evidence bundles. In the third category, software supply-chain provenance frameworks record post-hoc summaries of build and deployment events but do not maintain a continuous attestation chain linking every agent action, collaboration, and economic transaction within a unified trust boundary.

The present disclosure differs from each of the foregoing prior-art categories by combining all four elements—hardware-rooted self-sovereign agent identity, smart-contract-enforced economic incentives with automated slashing, post-quantum-secure verifiable collaboration, and continuous-attestation-chained provenance generating audit-ready cryptographic evidence—as a single cryptographically interlocked closed loop depicted collectively across FIGS. 1-5 and their sub-figures. Removal of any single element of this closed loop breaks the cryptographic trust guarantee and degrades the platform from a self-attesting trust system to a conventional aggregate of independent subsystems, as further set forth in paragraphs [0011a] and [0011b] below. A person of ordinary skill in the art, surveying the foregoing prior-art categories at the time of invention, would not have been motivated to combine their disparate teachings into the closed loop disclosed herein absent first recognizing the specific problem addressed by the present disclosure, namely the absence of regulator-grade audit evidence linking hardware-rooted agent identity, economic state, and post-quantum cryptographic protection in a single tamper-evident chain.

### TECHNICAL IMPROVEMENT AND MEASURABLE ADVANCES

In certain implementations, the invention is configured to provide technical improvements over prior approaches in at least the following respects:
(i) Attestation latency for agent spawn. Prior approaches relying on remote attestation services may incur substantial per-spawn attestation latency due to network round trips and centralized verification dependencies. In certain implementations of the present platform that employ locally-cached known-good whitelist verification within a dedicated management trusted execution environment (FIGS. 1E, 20), the platform is configured to reduce attestation latency relative to remote-attestation-service approaches by eliminating per-spawn external verifier round trips.
(ii) Audit-evidence assembly time. Prior approaches relying on manual cross-system log correlation may require significant human effort to assemble regulator-grade audit evidence for a single incident or audit cycle. In certain implementations, the present platform (FIGS. 4C, 76) is configured to reduce audit-evidence assembly time by performing automated query against the provenance ledger and Merkle-tree-based inclusion-path generation, producing deterministic evidence bundles without requiring manual log correlation across heterogeneous systems.
(iii) Post-incident forensic reconstruction time. Prior approaches relying on best-effort log aggregation may require extended manual effort to reconstruct the chain of agent actions leading to a security or compliance incident. In certain implementations, the present platform is configured to support deterministic retrieval of the chain of agent actions through query against anchored Merkle roots maintained by the provenance ledger (FIGS. 4, 70), with cryptographic verifiability at each step of the reconstructed chain.
(iv) Unconventional combination. The combination of hardware-rooted self-sovereign agent identity (FIGS. 1D, 18), smart-contract-enforced economic incentives and slashing (FIGS. 2, 30), post-quantum-secure verifiable collaboration (FIGS. 3, 50), and continuous-attestation-chained provenance producing audit-ready cryptographic evidence bundles (FIGS. 4, 70) is not generic, conventional, or routine in the relevant art. The technical improvements are achieved by the unconventional combination of: (a) executing all security-critical agent operations within attested trusted execution environments; (b) binding agent identities cryptographically to hardware-rooted measurements; (c) enforcing economic incentives via smart contracts whose execution and reward release are themselves gated by valid attestation; and (d) maintaining a continuous attestation chain feeding a tamper-evident provenance ledger from which audit-ready cryptographic evidence bundles are generated on demand.

The four constitutive elements of the platform—hardware-rooted self-sovereign agent identity, smart-contract-enforced economic incentives with automated slashing, post-quantum-secure verifiable collaboration, and continuous-attestation-chained provenance generating audit-ready cryptographic evidence—are not a mere aggregation of known components. Each element is cryptographically interlocked with the others such that removal of any single element breaks the closed loop and degrades the platform from a self-attesting trust system to a conventional aggregate. In particular: (a) smart-contract execution and reward release are gated by valid TEE attestation, such that an unattested agent cannot earn or distribute rewards; (b) reward and slashing events are themselves recorded as cryptographically-linked entries in the continuous attestation chain, such that the economic state of the system is inseparable from its attestation state; (c) audit-ready cryptographic evidence bundles are assembled by selecting inclusion paths through the same continuous attestation chain that gates reward release, such that evidence bundles cannot be produced retroactively from outside the trust boundary; and (d) the post-quantum signature primitives that sign reward transactions also sign agent attestation quotes, evidence bundles, and Merkle-root anchorings, such that cryptographic migration during a defined transition period is system-wide rather than per-component.

Unified Attestation-Economic-Provenance State Machine. The platform implements a unified attestation-economic-provenance state machine, depicted collectively across FIGS. 1-5 and their sub-figures, in which (i) attestation validation (FIGS. 1E, 20) gates each economic-state transition issued by the economic incentive engine (FIGS. 2, 30); (ii) each said economic-state transition, including reward issuance (FIGS. 2B, 34) and slashing (FIGS. 2E, 40), is cryptographically signed and committed to the continuous attestation chain maintained by the provenance ledger (FIGS. 4, 70); (iii) audit-ready cryptographic evidence bundles (FIGS. 4C, 76) are assembled by selecting inclusion paths through the same continuous attestation chain that gates the economic-state transitions; and (iv) the cryptographic primitives that sign attestation quotes, reward transactions, slashing events, and evidence bundles are unified under a common post-quantum or hybrid signature scheme, such that cryptographic migration during a defined transition period is system-wide rather than per-component. The four state components—attestation, economic, provenance, and evidence—are cryptographically interlocked: removal of any one component breaks the closed loop, disables generation of audit-ready cryptographic evidence bundles, and degrades the platform from a self-attesting trust system to a conventional aggregate. The improvement is therefore not achieved by combining known elements with predictable results, but by binding them through the unified state machine of FIGS. 1-5 whose security properties no constituent element provides alone.

### SUMMARY OF THE INVENTION

Disclosed are a system, a computer-implemented method, and a closed-loop attestation-economic-provenance-evidence state machine for autonomous multi-agent orchestration with tokenized economic incentives and smart-contract governance, executing security-critical operations within trusted execution environments and interacting with external distributed ledgers over cryptographically attested channels. The platform enables self-organizing agent swarms (FIGS. 1, 10), on-chain rewards (FIGS. 2, 30), policy-enforced collaboration (FIGS. 3, 50), automated slashing of non-compliant agents (FIGS. 2E, 40), cryptographically verifiable outcomes, and the generation of audit-ready cryptographic evidence bundles (FIGS. 4C, 76), while preserving hardware-rooted trust and post-quantum cryptographic resilience (FIGS. 5D, 98).

In one aspect, the platform (FIGS. 1, 10) comprises one or more hardware Trusted Execution Environments (TEEs); an orchestration engine executing within at least one of the one or more TEEs and configured to dynamically spawn, coordinate, and retire specialized artificial-intelligence agents and to perform hardware attestation validation (FIGS. 1E, 20); a self-sovereign agent identity module (FIGS. 1D, 18) configured to cryptographically bind each said agent to a hardware-rooted TEE measurement and to sealed keys held within at least one of the one or more TEEs; an economic incentive engine (FIGS. 2, 30) configured to issue tokenized rewards via one or more smart contracts according to a multi-factor contribution score and to apply automated slashing, wherein issuance of the rewards and execution of slashing are conditioned on valid TEE attestation; a tamper-evident provenance ledger (FIGS. 4, 70) configured to record agent actions, attestations, collaborations, the rewards, slashing events, and executions of the one or more smart contracts as a continuous attestation chain, with periodic Merkle-root anchoring to a distributed ledger or public blockchain; and an evidence generation module (FIGS. 4C, 76) configured to assemble audit-ready cryptographic evidence bundles from the continuous attestation chain, wherein receipts of smart-contract executions are bound to the continuous attestation chain prior to insertion.

In another aspect, a computer-implemented method comprises instantiating the one or more TEEs; dynamically spawning a plurality of the agents with self-sovereign identities bound to TEE measurements; performing hardware attestation validation; orchestrating inter-agent task allocation and collaboration over attested channels secured with post-quantum cryptography; recording inter-agent collaboration and outputs with zero-knowledge proofs; conditioning distribution of the tokenized rewards via the one or more smart contracts upon valid TEE attestation and successful verification of agent contributions; binding receipts of smart-contract executions to a continuous attestation chain maintained by a tamper-evident provenance ledger; and generating audit-ready cryptographic evidence bundles from data of the continuous attestation chain.

In a further aspect, the platform implements an attestation-economic-provenance-evidence state machine in which removal of any one of the attestation, economic, provenance, or evidence components breaks the cryptographic loop and disables generation of audit-ready cryptographic evidence bundles, the state machine being maintained by one or more processors operating within the one or more TEEs and recording each state transition as a cryptographically linked entry in the continuous attestation chain with periodic Merkle-root anchoring to a distributed ledger or public blockchain.

### DEFINITIONS

For the purposes of this disclosure, the following terms have the meanings set forth below. Where a term used herein is also defined in a referenced standard, the present definition controls.
“Trusted Execution Environment” means or “TEE,” a hardware-isolated execution context that protects code, data, and state from privileged software outside the enclave and produces hardware-rooted measurements usable for remote attestation, including without limitation Intel Trust Domain Extensions (TDX), AMD Secure Encrypted Virtualization with Secure Nested Paging (SEV-SNP), Amazon Web Services Nitro Enclaves, and ARM Confidential Compute Architecture (CCA).
“Autonomous Multi-Agent Orchestration” means the dynamic spawning, task allocation, coordination, monitoring, and retirement of specialized artificial-intelligence agents without continuous human intervention, as depicted across FIG. 1, including sub-figures FIG. 1A through FIG. 1E.
“Self-Sovereign Agent Identity” means a decentralized identifier (DID) cryptographically bound to a trusted-execution-environment measurement hash and to sealed private keys, enabling each agent to act independently while remaining cryptographically verifiable by third parties (FIGS. 1D, 18).
“Continuous Attestation Chain” means an unbroken cryptographic sequence of hardware-rooted attestations linking every stage of agent lifecycle, inter-agent collaboration, smart-contract execution, economic transactions including reward issuances and slashing executions, evidence-bundle generations, and governance events, each entry being cryptographically linked to the immediately preceding entry.
“Contribution Score” means a multi-factor metric calculated by the platform for each agent contribution (FIGS. 2A, 32), expressed as S=w₁·V+w₂·R+w₃·A+w₄·E, where V is a verification-success indicator, R is a risk-reduction measure, A is an alignment score, E is an efficiency measure, and w₁ through w₄ are configurable weight coefficients summing to unity. Default weights set forth in the Best Mode are illustrative and not limiting.
“Tokenized Reward” means a cryptographically signed, transferable utility or governance token issued via smart contract upon verified contribution (FIGS. 2B, 34), optionally signed using post-quantum digital signature algorithms including ML-DSA (Dilithium, FIPS 204), FN-DSA/Falcon (draft FIPS 206), or SLH-DSA (SPHINCS+, FIPS 205).
“Smart-Contract-Governed Collaboration” means the use of on-ledger smart contracts to enforce agent agreements, policy compliance, reward distribution, dispute resolution, slashing of non-compliant agents, and governance upgrade rules, as depicted across FIG. 3 (50).
“Provenance Ledger” means an append-only, cryptographically linked record of all agent actions, attestations, collaborations, rewards, slashing executions, evidence-bundle generations, and smart-contract executions, with periodic Merkle-root anchoring to a distributed ledger or public blockchain to provide third-party verifiability through proofs-of-inclusion (FIGS. 4, 70).
“Audit-Ready Cryptographic Evidence Bundle” means a self-contained, tamper-evident package comprising at least: (i) the agent decentralized identifier, (ii) the trusted-execution-environment attestation quote, (iii) a contribution hash, (iv) a smart-contract execution receipt, (v) a Merkle inclusion path to an anchored ledger root, (vi) a timestamp from a trusted time source, and (vii) a verification status indicator, the bundle being signed with the agent's sealed private key (FIGS. 4C, 76).
“Verifiable Collaboration” means inter-agent interactions recorded with zero-knowledge proofs and post-quantum attestation such that outcomes are independently auditable by parties not party to the original collaboration (FIGS. 3C, 56).
“Post-Quantum Cryptography” means cryptographic algorithms resistant to attacks by cryptographically relevant quantum computers, including without limitation the algorithms standardized or under draft standardization by the United States National Institute of Standards and Technology: ML-KEM (Kyber, FIPS 203), ML-DSA (Dilithium, FIPS 204), SLH-DSA (SPHINCS+, FIPS 205), and FN-DSA (the Fast-Fourier-Transform over NTRU-Lattice Digital Signature Algorithm, based on the Falcon submission and the subject of draft FIPS 206).
“Slashing” means the automated reduction, revocation, or forfeiture of an agent's tokenized rewards, staked tokens, reputation score, or, in non-tokenized embodiments, an automated debit operation against the agent's accumulated credit balance maintained as an attested internal accounting entry, by smart-contract execution or attested ledger entry upon detection of policy violation, failed attestation, or verifiable misconduct (FIGS. 2E, 40).
“Known-Good Whitelist” means a curated, signed set of acceptable trusted-execution-environment measurement values used by an attestation verifier to determine validity of an agent's hardware quote, the whitelist being created from manufacturer-provided reference measurements, updated through a secure multi-signature governance process, and protected within a dedicated management trusted execution environment.
“Zero-Knowledge Proof” means a cryptographic protocol by which a prover convinces a verifier of the truth of a statement without revealing any information beyond the validity of the statement, including without limitation Groth16, PLONK, Halo2, and STARK proof systems (FIGS. 3C, 56).
“Cryptographic Erasure” means the rendering of payload data referenced by ledger entries unrecoverable through deletion of the decryption key under which the payload data was encrypted, without modifying the integrity of the cryptographic links of the provenance ledger itself.

### BRIEF DESCRIPTION OF THE DRAWINGS

The disclosure is illustrated by five figures, each comprising five sub-figures, consisting of schematic block diagrams and flowcharts. Identical reference numerals denote identical or analogous elements throughout. Reference numerals appearing in parentheses below are those used in the drawings.

FIG. 1—MULTI-AGENT ORCHESTRATION ARCHITECTURE (10). FIG. 1A: Swarm coordination across federated trusted execution environments (12). FIG. 1B: Dynamic agent spawning, instantiation, and termination logic (14). FIG. 1C: Risk-aware task allocation and load-balancing engine (16). FIG. 1D: Self-sovereign identity issuance, sealing, and rotation (18). FIG. 1E: Cross-TEE mutual attestation and attested channel establishment (20).

FIG. 2—ECONOMIC INCENTIVE AND REWARD WORKFLOW (30). FIG. 2A: Contribution measurement and multi-factor scoring (32). FIG. 2B: Tokenized reward calculation and distribution via smart contract (34). FIG. 2C: Smart-contract bounty and escrow mechanisms (36). FIG. 2D: Reputation scoring and long-term incentive alignment (38). FIG. 2E: Dispute resolution and automated slashing on policy violation (40).

FIG. 3—SMART-CONTRACT-GOVERNED COLLABORATION (50). FIG. 3A: On-chain policy and agreement enforcement (52). FIG. 3B: Inter-agent negotiation and consensus protocols (54). FIG. 3C: Verifiable multi-agent code-generation sessions with zero-knowledge proofs (56). FIG. 3D: Automated reward distribution upon milestone verification (58). FIG. 3E: Governance voting and protocol upgrade mechanisms (60).

FIG. 4—INTEGRATION WITH VERIFICATION AND RISK SYSTEMS (70). FIG. 4A: Linkage to formal verification and runtime attestation (72). FIG. 4B: Risk-aware task prioritization (74). FIG. 4C: Audit-ready cryptographic evidence bundle generation (76). FIG. 4D: Feedback loops to predictive risk quantification (78). FIG. 4E: Third-party audit and verification interface (80).

FIG. 5—LIFECYCLE AND CROSS-SYSTEM ORCHESTRATION (90). FIG. 5A: Full agent lifecycle from spawn through quarantine to retirement (92). FIG. 5B: Automated insurance premium and capital reserve triggers from swarm outcomes (94). FIG. 5C: Cross-platform orchestration with upstream and downstream systems (96). FIG. 5D: Post-quantum key management and hybrid cryptographic transition (98). FIG. 5E: Disaster recovery, circuit-breaker, and swarm reconstitution protocols (100).

### DETAILED DESCRIPTION OF THE INVENTION

### Architectural Overview

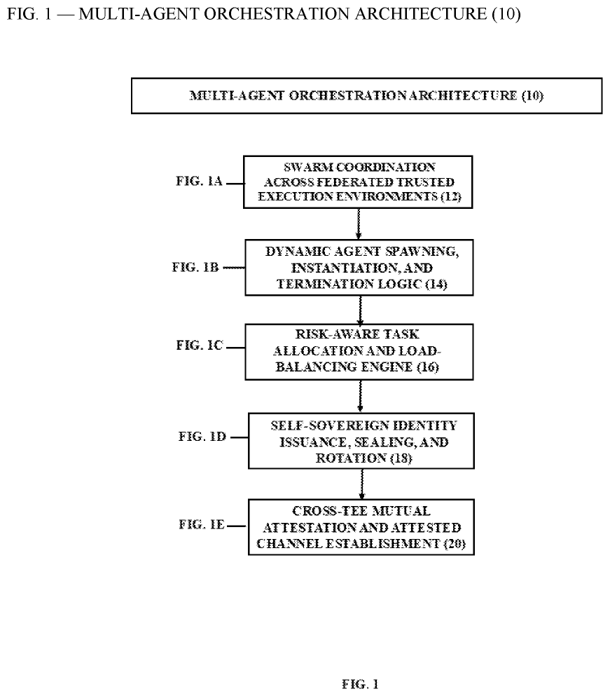

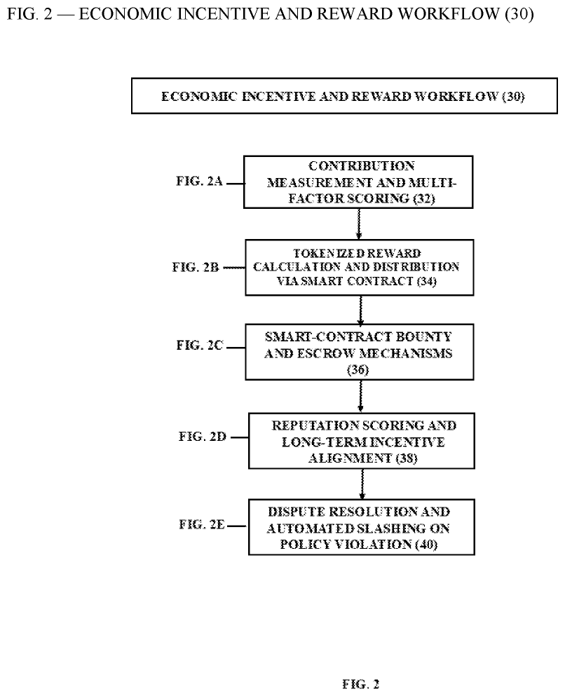

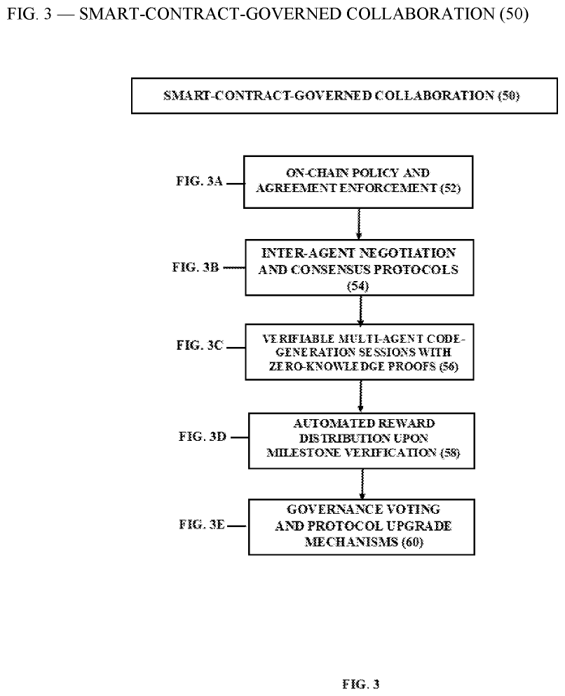

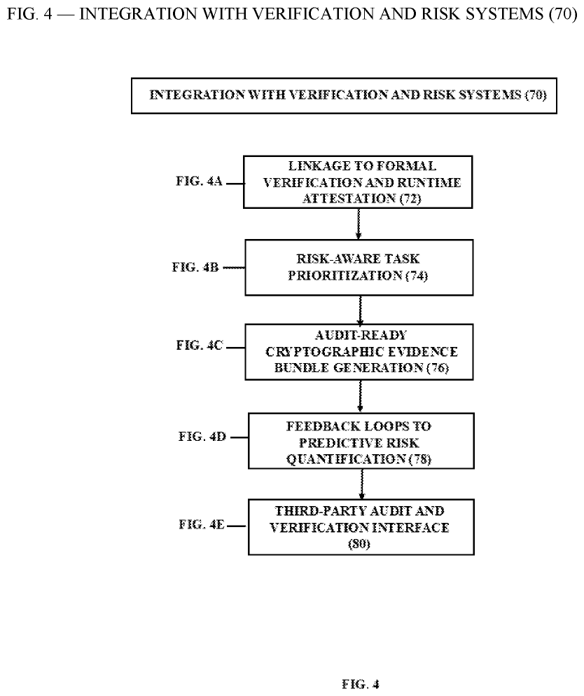

Referring to FIG. 1, the platform (10) executes its security-critical agent operations, the orchestration engine (depicted across FIG. 1A through FIG. 1E), self-sovereign identity management (FIGS. 1D, 18), and attestation validation (FIGS. 1E, 20) within one or more hardware Trusted Execution Environments, while smart-contract interactions with external distributed ledgers (depicted in FIG. 2B (34), FIG. 2C (36), FIG. 3A (52), and FIG. 3D (58)) and Merkle-root anchoring (FIGS. 4, 70) occur over cryptographically attested channels with their results bound back into the continuous attestation chain maintained by the platform. An autonomous orchestration engine, executing inside at least one of the one or more TEEs, dynamically spawns, coordinates, monitors, and retires specialized artificial-intelligence agents across one or more federated TEEs (FIGS. 1A, 12). Each said agent is instantiated (FIGS. 1B, 14) with a self-sovereign decentralized identifier cryptographically bound to a hardware-rooted trusted-execution-environment measurement hash and to sealed private keys held only within the enclave. Inter-agent collaboration occurs exclusively over attested channels established following successful mutual remote attestation (FIGS. 1E, 20).

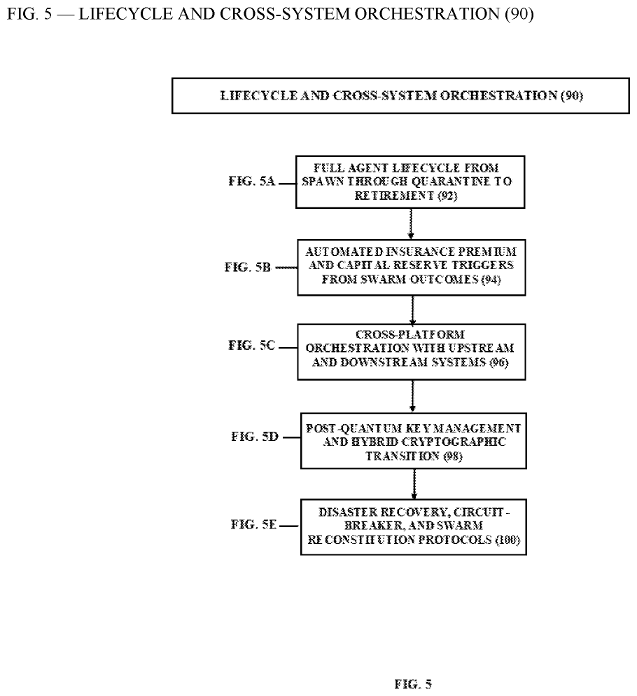

The platform comprises six principal subsystems, each tied to a specific drawing reference: (i) the orchestration engine (FIGS. 1, 10), depicted across FIG. 1A through FIG. 1E; (ii) the self-sovereign identity module (FIGS. 1D, 18); (iii) the economic incentive engine (FIGS. 2, 30), comprising contribution measurement and multi-factor scoring (FIGS. 2A, 32), tokenized reward calculation and distribution (FIGS. 2B, 34), smart-contract bounty and escrow mechanisms (FIGS. 2C, 36), reputation scoring (FIGS. 2D, 38), and dispute resolution and automated slashing (FIGS. 2E, 40); (iv) the smart-contract collaboration layer (FIGS. 3, 50), comprising on-chain policy and agreement enforcement (FIGS. 3A, 52), inter-agent negotiation and consensus protocols (FIGS. 3B, 54), verifiable multi-agent code-generation sessions (FIGS. 3C, 56), automated reward distribution (FIGS. 3D, 58), and governance voting and protocol upgrade mechanisms (FIGS. 3E, 60); (v) the verification and risk integration layer (FIGS. 4, 70), comprising formal verification and runtime attestation linkage (FIGS. 4A, 72), risk-aware task prioritization (FIGS. 4B, 74), audit-ready cryptographic evidence bundle generation (FIGS. 4C, 76), feedback loops to predictive risk quantification (FIGS. 4D, 78), and a third-party audit and verification interface (FIGS. 4E, 80); and (vi) the lifecycle and cross-system orchestration layer (FIGS. 5, 90), comprising full agent lifecycle management (FIGS. 5A, 92), automated insurance premium and capital reserve triggers (FIGS. 5B, 94), cross-platform orchestration (FIGS. 5C, 96), post-quantum key management and hybrid cryptographic transition (FIGS. 5D, 98), and disaster recovery, circuit-breaker, and swarm reconstitution protocols (FIGS. 5E, 100). Each security-critical subsystem executes within one or more of the one or more TEEs. Subsystems communicate across attested channels, and all cross-subsystem interactions are recorded in the provenance ledger (FIGS. 4, 70).

### Attestation Validation Flow

Referring to FIG. 1E (20), each TEE generates a hardware-rooted attestation quote comprising at least (i) the platform measurement, (ii) the agent code measurement, (iii) a freshly generated nonce, and (iv) optional user data binding the quote to a specific session or task. A remote verifier validates the quote signature against the hardware manufacturer's root of trust certificate chain and compares the measurement values against the known-good whitelist. Upon successful validation, sealed keys are released to the requesting enclave, a session key is established using post-quantum key encapsulation (ML-KEM), and an attested communication session is opened. The attestation validation flow is set forth in Listing 1 below.

### LISTING 1—Attestation Validation Flow

procedure ValidateAttestation(quote, agent_id, whitelist)
   if not VerifySignature(quote, manufacturer_root_of_trust)
      return REJECT
   end if
   measurements:=ExtractMeasurements(quote)
   if measurements not in whitelist
      return REJECT
   end if
   if not VerifyNonce(quote, expected_nonce)
      return REJECT
   end if
   freshness:=CurrentTime( )−quote.timestamp
   if freshness>FRESHNESS_WINDOW
      return REJECT // window configurable
   end if
   sealed_keys:=RetrieveSealedKeys(agent_id, measurements)
   session_key:=EstablishSessionKey(quote.public_key) // ML-KEM
   RecordEvent(provenance_ledger, ATTEST_OK, agent_id, quote)
   return (ACCEPT, sealed_keys, session_key)
end procedure

The known-good whitelist is initially populated from manufacturer-provided reference measurements obtained through authenticated supply-chain channels. The whitelist is periodically updated through a secure multi-signature governance process requiring a configurable threshold of authorized signers and is protected within a dedicated management TEE isolated from agent workloads. Updates are recorded as events in the provenance ledger (FIGS. 4, 70). Each whitelist version is Merkle-tree-hashed and the root is anchored to a public blockchain.

### Self-sovereign Agent Identity

Referring to FIG. 1D (18), each agent is provisioned with a decentralized identifier conforming to the W3C DID specification. The identifier is cryptographically derived from the agent's TEE measurement hash and a freshly generated key pair, the private key of which is sealed inside the enclave and never exposed to external software. The decentralized identifier document includes (i) the agent's public verification key, (ii) the agent's public key-encapsulation key, (iii) a service endpoint for attested communication, and (iv) a reference to the attestation evidence sufficient to allow third-party verification of the binding.

### Economic Incentive Engine

Referring to FIG. 2 (30), the economic incentive engine issues tokenized rewards to agents based on the Contribution Score S=w₁·V+w₂·R+w₂·A+w₄·E, where V denotes verification success (binary or graded), R denotes risk-score reduction relative to a configured baseline, A denotes alignment with declared policy and safety specifications, and E denotes efficiency in resource consumption and latency. Weights w₁ through w₄ are configurable per deployment and per smart-contract policy, and sum to unity. Rewards may be issued in utility tokens, governance tokens, reputation points, or any combination thereof, and may be subject to vesting, escrow, or milestone gating. The Contribution Score computation is set forth in Listing 2 below.

### LISTING 2 —Contribution Score Calculation

procedure ComputeContributionScore(agent_id, task_output)
   V:=VerificationSuccess(task_output) // 0..1
   R:=RiskScoreReduction(task_output, baseline)// 0..1
   A:=AlignmentScore(task_output, policy_spec) // 0..1
   E:=EfficiencyMeasure(task_output, log) // 0..1
   assert w1+w2+w3+w4==1.0
   S:=w1*V+w2*R+w3*A+w4*E
   RecordEvent(provenance_ledger, SCORE, agent_id, S, [V, R, A, E])
   return S
end procedure

Computation of the Contribution Score components V (verification success) and A (alignment) is performed within the trust boundary of one or more TEEs (FIGS. 1, 10; FIGS. 2A, 32) and may incorporate formal-methods verification, runtime monitoring, cross-agent zero-knowledge consistency checks (FIGS. 3C, 56), and policy-compliance attestation prior to scoring and reward issuance. In one implementation, V is computed as a weighted combination of (i) formal-verification proof acceptance against a policy-specified property set, (ii) test-suite pass rate against a deterministic test harness executing within the TEE, and (iii) cross-agent zero-knowledge consistency among independent verification agents; A is computed as a weighted combination of (i) policy-compliance attestation against a declared safety specification, (ii) divergence measures against a reference output distribution, and (iii) hallucination-mitigation indicators including consistency checks between generated content and retrieved authoritative source material. The resulting V and A values are signed by the agent's sealed key prior to entry into the continuous attestation chain, such that no reward or ledger entry can be issued from an agent output that has not been verified within an attested context. Hallucinated, divergent, or policy-non-compliant outputs are reflected as low V and A scores, resulting in reduced or zero reward and, in repeated cases, triggering of the dispute resolution and automated slashing subsystem (FIGS. 2E, 40).

Reward transactions may be signed using post-quantum digital signature algorithms in either (a) a pure post-quantum mode using ML-DSA, FN-DSA (Falcon), or SLH-DSA, or (b) a hybrid mode that combines a classical signature algorithm (such as Ed25519 or ECDSA) with a post-quantum signature algorithm during a defined cryptographic transition period. In the hybrid mode, verification requires success of both signature checks.

In an alternative embodiment, rewards are issued as non-tokenized internal accounting entries rather than as on-chain tokens. In this embodiment, the economic incentive engine (FIGS. 2, 30) writes credit and debit entries to an attested internal ledger maintained within at least one of the one or more TEEs, with each entry signed by the entry-creator's sealed private key and committed to the continuous attestation chain. Slashing is implemented by symmetric debit operations against the agent's accumulated credit balance. The agent's reputation score is updated identically whether rewards are tokenized or accounting-entry-based. This embodiment is suitable for deployments in regulated environments where token issuance is prohibited or where the operating entity prefers to retain rewards as off-balance-sheet operational credits rather than transferable assets. Hybrid embodiments are also contemplated in which a portion of an agent's rewards are issued as tokenized rewards and a portion as non-tokenized accounting entries, with the split configurable through the Governance contract. All other features of the platform—attestation validation, evidence-bundle generation (FIGS. 4C, 76), continuous attestation chain maintenance, and Merkle-root anchoring—operate identically across tokenized, non-tokenized, and hybrid reward embodiments.

### Slashing Mechanism

Referring to FIG. 2E (40), upon detection of policy violation, failed attestation, verifiable misconduct, or smart-contract-specified anomalous behavior, the dispute resolution and automated slashing subsystem reduces, revokes, or forfeits an agent's rewards, staked tokens, or reputation score (or, in non-tokenized embodiments, debits the agent's accumulated credit balance) by automatic smart-contract execution or attested ledger entry. Slashing rules are codified in industry-and policy-specific smart contracts, are publicly verifiable, and trigger contemporaneous emission of provenance-ledger events that feed downstream into reputation scoring and future task allocation. Slashing magnitudes are determined by the applicable smart-contract policy and may scale with the severity of the detected violation, the agent's prior reputation, and the value at risk in the underlying collaboration. The slashing trigger logic is set forth in Listing 3 below.

### LISTING 3—Slashing Trigger Logic

procedure EvaluateSlashing(agent_id, event)
   if event.type in {POLICY_VIOLATION, ATTESTATION_FAIL, MISCONDUCT}
      severity:=ClassifySeverity(event)
      penalty:=PolicyContract. ComputePenalty(severity, agent_id. reputation)
      receipt:=SmartContract. Slash(agent_id, penalty) // gas budget configurable
      RecordEvent(provenance_ledger, SLASH, agent_id, penalty, receipt)
      UpdateReputation(agent_id,-penalty)
      if SlashFrequency(agent_id, window=SLASH_WINDOW)>=THRESHOLD
         Quarantine(agent_id)
         CircuitBreaker. Trip(agent_id.smart_contracts)
      end if
   end if
end procedure

### Smart-Contract Architecture

Referring to FIG. 3 (50), the smart-contract layer is structured as a set of modular, upgradable contracts deployed to an Ethereum-compatible Layer-2 network or equivalent platform. The modules include: (i) an Agent Registry contract that records agent decentralized identifiers and attestation hashes; (ii) an Escrow contract (FIGS. 2C, 36) that holds reward tokens pending verification; (iii) a Reward Distribution contract (FIGS. 2B, 34; FIGS. 3D, 58) that disburses tokens upon verified contribution; (iv) a Slashing contract (FIGS. 2E, 40) that enforces penalty rules; (v) a Reputation contract (FIGS. 2D, 38) that aggregates long-term performance scores; (vi) a Governance contract (FIGS. 3E, 60) that manages protocol parameter upgrades through token-weighted voting with time-locked admin functions; and (vii) an Audit contract (FIGS. 4E, 80) that exposes evidence-bundle generation interfaces to external auditors. Modules communicate through versioned interfaces and may be upgraded independently subject to governance approval.

Although smart contracts execute on external distributed ledgers, as depicted in FIG. 2B (34), FIG. 2C (36), FIG. 3A (52), and FIG. 3D (58), only receipts and events originating from attested agent identities are accepted by the platform and recorded in the provenance ledger (FIGS. 4, 70). Smart-contract execution receipts received from external ledgers are validated against the attested public keys of the issuing agents prior to insertion into the continuous attestation chain, and any receipt failing such validation is rejected and logged as an anomaly event subject to the dispute resolution and automated slashing subsystem (FIGS. 2E, 40). External-ledger reorganizations, finality reversions, or chain forks are detected by comparing newly received receipts against the locally maintained continuous attestation chain, and any divergent receipt is similarly treated as an anomaly event. In this manner, the platform's trust boundary extends through the attested-channel layer to the external smart-contract execution result without admitting unattested actors into the closed loop.

### Zero-knowledge Proof Systems

Referring to FIG. 3C (56), inter-agent collaboration is recorded with zero-knowledge proofs selected based on use-case requirements. Suitable proof systems include Groth16 (offering minimal proof size and rapid verification at the cost of a per-circuit trusted setup), PLONK (offering a universal trusted setup), Halo2 (offering no trusted setup at the cost of larger proofs), and STARK-based systems (offering no trusted setup and post-quantum security at the cost of larger proof size). The platform supports concurrent operation of multiple proof systems and migration between proof systems through versioned policy updates recorded in the provenance ledger.

### Token Economics Model

The platform supports three classes of digital assets: (i) utility tokens used as the medium of reward for verified contributions and as the unit of account for staking and slashing; (ii) governance tokens used for token-weighted voting on protocol parameter changes and module upgrades; and (iii) non-transferable reputation points accrued by agents through sustained verified contribution. Non-transferability of reputation refers to peer-to-peer transferability between agents; platform-level adjustment of reputation balances by smart-contract slashing remains permitted and is not a transfer. Utility tokens may be subject to vesting schedules, time-locks, and milestone-gated release. Slashing reduces utility-token balances and reputation scores but does not directly affect governance-token holdings, although severe or repeated violations may trigger governance-vote-driven revocation of governance tokens. Reward issuance is subject to a configurable emission schedule that may include inflation, deflation, or fixed-supply parameters.

### Provenance Ledger

Referring to FIG. 4 (70), all agent actions, attestation events, inter-agent collaborations, smart-contract executions, reward distributions, slashing executions, and evidence-bundle generations are recorded in an append-only, cryptographically linked provenance ledger. The ledger is structured as a Merkle tree whose roots are periodically anchored to a distributed ledger or public blockchain. Third parties may verify any recorded event by presenting a proof-of-inclusion against an anchored root.

Personally identifiable information and other sensitive payload data are maintained off the provenance ledger; the provenance ledger stores only cryptographic hashes, attestation quotes, signature material, and verification outcomes. In implementations subject to data-subject deletion rights (including without limitation Article 17 of the European Union General Data Protection Regulation and analogous provisions in other jurisdictions), the platform applies cryptographic erasure: payload data referenced by ledger entries is encrypted under per-subject or per-session keys held in TEE-sealed storage, and deletion of the decryption key renders the referenced payload data unrecoverable without modifying the integrity of the cryptographic links of the provenance ledger itself. Differential-privacy techniques may additionally be applied to aggregate telemetry prior to external publication, with privacy budget consumption recorded as a provenance-ledger event.

### Audit-ready Cryptographic Evidence Bundle

Referring to FIG. 4C (76), the audit-ready cryptographic evidence bundle generation subsystem generates, on demand or upon configured triggers, a self-contained, tamper-evident evidence bundle comprising: (i) the agent decentralized identifier; (ii) the TEE attestation quote; (iii) a contribution hash linking the agent's output to the final code or model artifact; (iv) the smart-contract execution receipt for any associated reward or slashing event; (v) a Merkle inclusion path proving recording in the provenance ledger; (vi) a timestamp from a trusted time source; and (vii) a verification status indicator. The bundle is signed with the agent's sealed private key and is suitable for regulatory submission, third-party audit, insurance claims defense, and litigation discovery. Bundle generation is itself recorded in the provenance ledger to provide chain-of-custody evidence. The bundle assembly procedure is set forth in Listing 4 below.

### LISTING 4—Audit-ready Evidence Bundle Assembly

procedure AssembleEvidenceBundle(agent_id, contribution_id)
   did:=Lookup(agent_id)
   quote:=AttestationCache(agent_id, contribution_id)
   contrib_hash:=Hash(ContributionData(contribution_id))
   receipt:=SmartContract. GetReceipt(contribution_id)
   inclusion_path:=MerkleProof(provenance_ledger, contribution_id)
   timestamp:=TrustedTime( )
   status:=VerifyAll(quote, receipt, inclusion_path)
   bundle:={did, quote, contrib_hash, receipt,
      inclusion_path, timestamp, status}
   signature:=SealedSign(bundle, agent_id.sealed_key) // ML-DSA
   RecordEvent(provenance_ledger, BUNDLE_EMIT, agent_id, contribution_id)
   return (bundle, signature)
end procedure

### Verifiable Collaboration

Referring to FIG. 3C (56), inter-agent collaboration is conducted over attested, end-to-end-encrypted channels secured with post-quantum key encapsulation (ML-KEM, FIPS 203) and signed with post-quantum digital signatures (ML-DSA, FN-DSA/Falcon, or SLH-DSA). Sensitive inter-agent exchanges, including intermediate reasoning steps and proprietary context, are recorded as zero-knowledge proofs that demonstrate compliance with declared policies without revealing the underlying content. Differential-privacy techniques may be applied to telemetry and aggregate collaboration data prior to publication or external audit, with privacy budget tracking recorded in the provenance ledger.

### Dynamic Swarm Reconfiguration and Cryptographic Fallback

Referring to FIG. 5E (100), the orchestration engine monitors risk signals, verification outcomes, attestation continuity, and smart-contract anomalies in real time. On detection of degraded conditions, the platform performs one or more of: (a) reassignment of in-flight tasks to alternate agents; (b) quarantine of suspect agents with sealed-state preservation for forensic analysis; (c) circuit-breaker suspension of affected smart contracts pending governance review; (d) declaration of a TEE compromise with revocation of dependent attestations and rotation to alternate hardware platforms; and (e) swarm reconstitution through respawning of trusted agent populations from sealed templates.

In the event of cryptanalytic compromise or formal weakening of a post-quantum primitive in active use by the platform, the lifecycle and cross-system orchestration layer (FIGS. 5D, 98; FIGS. 5E, 100) executes a coordinated fallback protocol comprising: (i) circuit-breaker suspension of affected smart contracts and economic-state transitions; (ii) rotation of agent signing and key-encapsulation keys to an alternative post-quantum primitive selected from the platform's supported algorithm set; (iii) re-attestation of all active agents against the rotated cryptographic configuration; (iv) re-signing of pending evidence bundles under the rotated primitives during a defined transition period in which both legacy and rotated signatures are concurrently accepted; and (v) continuation of the continuous attestation chain across the rotation, with the rotation event itself recorded as a provenance-ledger entry signed by the multi-signature governance keys. Swarm reconstitution from sealed templates (FIGS. 5E, 100) is performed concurrently where attestation continuity cannot be preserved. The continuous attestation chain remains unbroken across cryptographic rotations through use of hybrid signature envelopes that bind legacy and rotated signatures into a single committed entry.

### Operational Parameters and Configurable Ranges

The following operational parameters and bounded ranges are disclosed for use with the present platform. The recited ranges and any reference values within them are illustrative and not limiting; each parameter is configurable through the Governance contract subject to time-locked admin functions, and no specific value is required by the disclosure:
Attestation freshness window: configurable, in certain embodiments within a range from approximately 60 seconds to approximately 300 seconds. Quotes older than the configured freshness window are rejected by the attestation verifier.
Circuit-breaker activation thresholds: configurable; in certain embodiments, at least three attestation failures within a rolling window of approximately 60 seconds, or a risk-score delta exceeding a configurable threshold within a rolling window of several minutes. Either condition triggers suspension of the affected smart contracts.
Block-confirmation depth for anchoring finality: configurable per ledger; in certain embodiments, a confirmation depth selected according to the specific ledger's finality characteristics.
Merkle-root anchoring frequency: configurable, in certain embodiments within a range from approximately 1 minute to approximately 60 minutes between successive anchorings.
Swarm reconstitution Recovery Time Objective (RTO): configurable target; the specific RTO value is not a limitation of the invention.
Swarm reconstitution Recovery Point Objective (RPO): configurable target; the specific RPO value is not a limitation of the invention.
Gas budget bounds per smart-contract operation: configurable upper bounds for reward distribution, slashing, and audit-ready evidence bundle generation, with operations exceeding the configured bound rejected by the Governance contract.
Reward emission schedule: configurable decay constant, half-life, and emission ceiling per token class.
Contribution Score weights: configurable in the range 0.0 to 1.0 subject to the constraint w₁+w₂+w₃+w₄=1.0; specific reference values are set forth in the Best Mode and are illustrative only.
Multi-signature threshold for known-good whitelist governance: configurable M-of-N, with threshold M and signer set N controlled by the Governance contract.
Attestation latency: in certain implementations employing locally-cached whitelist verification within the dedicated management TEE, the platform may be configured to perform attestation validation at reduced latency relative to remote-attestation-service approaches. No specific latency threshold is required by the disclosure.

### Threat Model and Trust Assumptions

The platform's security relies on the following trust assumptions: (i) the integrity of TEE hardware and its attestation chain from the manufacturer's root of trust; (ii) the soundness of the post-quantum cryptographic primitives selected; (iii) the integrity of the multi-signature governance process maintaining the known-good whitelist; and (iv) the availability and integrity of the public blockchain used for Merkle-root anchoring. Defense in depth is provided by supporting multiple TEE vendors so that compromise of any single vendor does not compromise the platform; by supporting hybrid classical-and-post-quantum cryptography during transition periods; by requiring multi-signature thresholds for whitelist governance; by anchoring to public blockchains with independent operator sets; and by the cryptographic fallback protocol set forth in paragraph [0037a]. Side-channel attack resistance is deferred to the TEE vendor's mitigations and supplemented at the application layer by constant-time implementations of all cryptographic operations.

### Integration With External Systems

The platform exposes interfaces for integration with (i) formal verification systems whose proofs feed the V component of the Contribution Score (FIGS. 4A, 72); (ii) predictive risk-quantification systems whose forecasts feed the R component and inform task prioritization (FIGS. 4D, 78); (iii) runtime attestation services maintaining the continuous attestation chain (FIGS. 4A, 72); (iv) post-quantum key management systems providing key generation, rotation, and secure destruction (FIGS. 5D, 98); and (v) autonomous insurance and capital-reserve systems that adjust premiums or reserve requirements based on swarm performance and audit-ready cryptographic evidence bundles (FIGS. 5B, 94). Each integration interface is exposed through an attested endpoint and all integration interactions are recorded in the provenance ledger.

### ENABLEMENT EXAMPLES

Example 1—Healthcare Clinical Decision Support. A swarm comprising a generation agent, two verification agents, a compliance agent, and a safety agent (instantiated as depicted in FIG. 1B (14)) collaborates within Intel TDX TEEs (FIGS. 1, 10) to produce and verify a new clinical decision support module. The orchestration engine spawns agents from measurement-bound templates, escrows reward tokens in a healthcare-policy smart contract (FIGS. 2C, 36), and gates release on formal verification of the generated code and risk-score reduction below a configured threshold. Upon successful verification, tokens are distributed according to Contribution Scores (FIGS. 2B, 34). An audit-ready cryptographic evidence bundle (FIGS. 4C, 76) is generated for the institutional review board and the cyber-insurance carrier, and the module is deployed under continuous runtime attestation (FIGS. 4A, 72). A subsequent attestation failure triggers automatic quarantine of the failing agent, slashing of its tokenized rewards by a smart-contract-specified penalty (FIGS. 2E, 40), and reconstitution of the swarm from sealed templates within the configured Recovery Time Objective (FIGS. 5E, 100).

Example 2—High-Frequency Trading Component. A swarm of agents collaborates within AWS Nitro Enclaves (FIGS. 1, 10) to iterate versions of a high-frequency trading component. Economic incentives drive rapid iteration; smart contracts enforce pre-trade regulatory compliance gates and post-trade reporting (FIGS. 3A, 52); tokenized rewards are issued via post-quantum-signed transactions on an Ethereum-compatible Layer-2 network using ML-DSA signatures (FIGS. 5D, 98); and successful deployment triggers updates to capital reserve requirements (FIGS. 5B, 94) and swarm reputation scores (FIGS. 2D, 38). A what-if simulation module operating inside the dedicated management TEE evaluates alternative swarm configurations and reward parameterizations before production deployment, with all simulation runs recorded as events in the provenance ledger (FIGS. 4, 70). An audit-ready cryptographic evidence bundle (FIGS. 4C, 76) is generated for the relevant exchange and clearing-house oversight.

Example 3—Enterprise Software Supply Chain. A swarm of agents collaborates within AMD SEV-SNP TEEs (FIGS. 1, 10) to produce, verify, and continuously audit components of an enterprise software supply chain. Generation agents produce code from natural-language specifications; verification agents apply formal verification, fuzz testing, and dependency vulnerability scanning (FIGS. 4A, 72); compliance agents enforce regulatory and licensing policies through industry-specific smart contracts (FIGS. 3A, 52); and an audit agent generates audit-ready cryptographic evidence bundles (FIGS. 4C, 76) linking each delivered artifact to the agents, attestations, and verifications that produced it. The evidence bundles are signed, anchored to a public blockchain, and made available to downstream consumers of the software through the audit interface (FIGS. 4E, 80), enabling cryptographically verifiable end-to-end supply-chain provenance for AI-generated software and models.

### BEST MODE

The best mode contemplated by the inventor employs Intel TDX or AWS Nitro Enclaves as the TEE (FIGS. 1, 10); decentralized identifiers conforming to the W3C DID specification (FIGS. 1D, 18); an Ethereum-compatible Layer-2 smart-contract platform supporting low-latency transaction confirmation and post-quantum signature support (FIGS. 3, 50); ML-KEM key encapsulation and ML-DSA digital signatures during the post-quantum transition period operated in the hybrid mode alongside classical Ed25519 signatures (FIGS. 5D, 98); a Hyperledger-Fabric-based or purpose-built confidential provenance ledger with Merkle-root anchoring to a distributed ledger or public blockchain at a configurable cadence, in one preferred but non-limiting implementation on the order of approximately ten minutes between anchorings (FIGS. 4, 70); reference Contribution Score weights of w₁=0.40, w₂=0.25, w₃=0.20, w₄=0.15 (FIGS. 2A, 32), provided as illustrative defaults and not as limitations of the invention; PLONK or Halo2 as the zero-knowledge proof system for inter-agent collaboration (FIGS. 3C, 56); and a five-of-nine multi-signature threshold for known-good whitelist governance, again provided as an illustrative default and not as a limitation of the invention.

### ALTERNATIVES AND SCOPE OF THE DISCLOSURE

Components disclosed herein may be combined, distributed, omitted, or supplemented without departing from the scope of the disclosure. Alternative TEE technologies, alternative smart-contract platforms, alternative post-quantum algorithm selections, alternative reward and slashing models, alternative zero-knowledge proof systems, and alternative consensus protocols are expressly contemplated. The disclosure extends to non-code artifacts including artificial-intelligence model weights, fine-tuning datasets, configuration manifests, and inference policies, and to hybrid human-AI governance arrangements in which human reviewers participate as attested actors within the same trust framework. Best mode is disclosed through the concrete platforms, algorithms, default parameter values, and integration flows described herein; nothing in this disclosure shall be construed to limit the scope of any claim to the best mode disclosed.

### INDUSTRIAL APPLICABILITY

The invention is industrially applicable in any field in which autonomous artificial-intelligence agents produce, verify, or govern software, models, or other digital artifacts under conditions requiring hardware-rooted trust, economic alignment, regulator-grade audit evidence, or post-quantum cryptographic protection. Applications include without limitation healthcare clinical decision support, financial services trading and compliance, defense and intelligence software development, enterprise software supply chains, autonomous vehicle software, industrial control systems, and regulated artificial-intelligence deployment under emerging frameworks including the European Union Artificial Intelligence Act and equivalent national regimes.

What is claimed is:

1. A zero-trust autonomous multi-agent platform for trusted artificial-intelligence code generation and governance (FIG. 1, 10), the platform comprising:
(a) one or more hardware Trusted Execution Environments (TEEs) and an orchestration engine executing within at least one of the one or more TEEs and configured to (i) dynamically spawn, coordinate, and retire specialized artificial-intelligence agents and (ii) perform hardware attestation validation against hardware-rooted attestation quotes generated by the one or more TEEs, as depicted across FIG. 1 (10) including sub-figures FIG. 1A through FIG. 1E;
(b) a self-sovereign agent identity module (FIG. 1D, 18) configured to cryptographically bind each said agent to a hardware-rooted TEE measurement and to sealed keys held within at least one of the one or more TEEs;
(c) an economic incentive engine (FIG. 2, 30) configured to (i) issue rewards, including tokenized rewards via one or more smart contracts, according to a multi-factor contribution score, and (ii) apply automated slashing of an agent's rewards, staked tokens, reputation score, or, in non-tokenized embodiments, an accumulated credit balance, upon detection of policy violation, failed attestation, or verifiable misconduct, wherein issuance of the rewards and execution of slashing are conditioned on valid TEE attestation of the agent;
(d) a smart-contract collaboration layer (FIG. 3, 50) interfacing with one or more distributed ledgers over cryptographically attested channels, wherein receipts of executions of the one or more smart contracts are validated against attested public keys of issuing agents and are bound to a continuous attestation chain prior to insertion into a provenance ledger;
(e) a verification and risk integration layer (FIG. 4, 70) including an evidence generation module (FIG. 4C, 76) configured to assemble, from the continuous attestation chain, audit-ready cryptographic evidence bundles each comprising at least an agent decentralized identifier, a TEE attestation quote, a contribution hash, a smart-contract execution receipt, a Merkle inclusion path to an anchored Merkle root, a timestamp from a trusted time source, and a verification status indicator, each said bundle being signed with a sealed private key of an agent;
(f) a lifecycle and cross-system orchestration layer (FIG. 5, 90) configured to perform agent lifecycle management, automated insurance premium and capital-reserve triggering, cross-platform orchestration with upstream and downstream systems, post-quantum key management and hybrid cryptographic transition, and disaster-recovery, circuit-breaker, and swarm-reconstitution protocols; and
(g) a tamper-evident provenance ledger (FIG. 4, 70) configured to record agent actions, attestations, collaborations, the rewards, slashing events, evidence-bundle generations, and executions of the one or more smart contracts as the continuous attestation chain, the tamper-evident provenance ledger applying periodic Merkle-root anchoring to a distributed ledger or public blockchain, and the continuous attestation chain providing the data source from which the evidence generation module of element (e) assembles the audit-ready cryptographic evidence bundles.

2. A computer-implemented method for secure autonomous artificial-intelligence collaboration, the method comprising:
(a) instantiating one or more Trusted Execution Environments (TEEs);
(b) dynamically spawning a plurality of specialized artificial-intelligence agents with self-sovereign identities cryptographically bound to TEE measurements of the one or more TEEs;
(c) performing hardware attestation validation including (i) generation of an attestation quote by each of the one or more TEEs, (ii) validation of the attestation quote by a verifier, (iii) comparison of measurement values from the attestation quote against a known-good whitelist, and (iv) conditional release of sealed keys upon successful validation;
(d) orchestrating inter-agent task allocation and collaboration over attested channels secured with post-quantum cryptography;
(e) recording inter-agent collaboration and agent outputs with zero-knowledge proofs;
(f) conditioning distribution of tokenized rewards via one or more smart contracts upon valid TEE attestation and successful verification of agent contributions;
(g) binding receipts of executions of the one or more smart contracts to a continuous attestation chain maintained by a tamper-evident provenance ledger; and
(h) generating audit-ready cryptographic evidence bundles from data of the continuous attestation chain for regulatory submission or third-party audit.

3. A trusted-execution-environment-anchored state machine for autonomous artificial-intelligence agent orchestration, the state machine comprising:
(a) an attestation-state component (FIG. 1E, 20) configured to validate hardware-rooted attestations of one or more artificial-intelligence agents and to gate state transitions on validation success;
(b) an economic-state component (FIG. 2, 30) configured to issue rewards and to apply slashing upon state transitions, wherein each issuance and each slashing execution is cryptographically signed with a key sealed within the same trust boundary as the attestation-state component;
(c) a provenance-state component (FIG. 4, 70) configured to record each attestation-state transition and each economic-state transition as a cryptographically linked entry in a continuous attestation chain, the continuous attestation chain being periodically Merkle-root anchored to a distributed ledger or public blockchain; and
(d) an evidence-state component (FIG. 4C, 76) configured to assemble, on demand, audit-ready cryptographic evidence bundles by selecting inclusion paths through the continuous attestation chain,
wherein removal of any one of the attestation-state, economic-state, provenance-state, or evidence-state components breaks the cryptographic loop and disables generation of audit-ready cryptographic evidence bundles.

4. The platform of claim 1, wherein the one or more TEEs are selected from the group consisting of Intel Trust Domain Extensions (TDX), AMD Secure Encrypted Virtualization with Secure Nested Paging (SEV-SNP), Amazon Web Services Nitro Enclaves, and ARM Confidential Compute Architecture (CCA).

5. The platform of claim 1, wherein the economic incentive engine calculates the multi-factor contribution score as a weighted sum S=w₁·V+w₂·R+w₃·A+w₄·E of a verification-success indicator V, a risk-score reduction measure R, an alignment score A, and an efficiency measure E, the weights w₁ through w₄ being configurable and summing to unity, and wherein V and A are computed within the trust boundary of at least one of the one or more TEEs using one or more of formal-methods verification, runtime monitoring, and cross-agent zero-knowledge consistency checks prior to entry of the multi-factor contribution score into the continuous attestation chain.

6. The platform of claim 1, further comprising a zero-knowledge inter-agent communication module (FIG. 3C, 56) configured to record collaborative exchanges as zero-knowledge proofs that demonstrate policy compliance without revealing underlying content, the zero-knowledge proofs being selected from the group consisting of Groth16, PLONK, Halo2, and STARK proof systems.

7. The platform of claim 5, further comprising policy enforcement via the one or more smart contracts configured to gate distribution of the rewards, agent participation, and access to designated collaboration channels based on the multi-factor contribution score.

8. The platform of claim 1, further comprising dynamic swarm reconfiguration logic responsive to risk signals, verification failures, or attestation discontinuities, the dynamic swarm reconfiguration logic configured to perform task reassignment, agent quarantine, and circuit-breaker suspension of affected ones of the one or more smart contracts (FIG. 5E, 100).

9. The platform of claim 8, wherein each of the agents is dynamically instantiated and attested on-demand for a collaboration task and is retired with sealed-state preservation following task completion, task failure, or quarantine.

10. The platform of claim 1, further comprising a smart-contract interface configured to trigger autonomous insurance premium adjustment, capital-reserve adjustment, or both, based on swarm performance and the audit-ready cryptographic evidence bundles (FIG. 5B, 94).

11. The platform of claim 1, further comprising a what-if simulation module executing entirely within at least one of the one or more TEEs and configured to evaluate alternative swarm configurations, reward parameterizations, and economic outcomes prior to production deployment.

12. The platform of claim 1, wherein the hardware attestation validation comprises comparing TEE measurement values against a known-good whitelist that is (i) created from manufacturer-provided reference measurements, (ii) updated through a secure multi-signature governance process requiring a configurable threshold of authorized signers, and (iii) protected within a dedicated management TEE isolated from agent workloads.

13. The platform of claim 12, wherein the orchestration engine is further configured to perform the hardware attestation validation locally within the dedicated management TEE against the known-good whitelist cached therein, thereby reducing attestation latency relative to remote-attestation-service approaches and removing the remote verifier from the per-spawn trust path.

14. The platform of claim 1, wherein the rewards comprise non-tokenized internal accounting entries written to an attested internal ledger maintained within at least one of the one or more TEEs, each said entry being signed by a sealed private key and committed to the continuous attestation chain, and wherein slashing is implemented as a debit operation against an accumulated credit balance, the platform retaining identical attestation validation, evidence-bundle generation, continuous attestation chain maintenance, and Merkle-root anchoring across tokenized, non-tokenized, and hybrid reward embodiments.

15. The platform of claim 1, wherein the economic incentive engine is configured to operate during a defined cryptographic transition period in a hybrid mode combining one or more classical signature algorithms and one or more post-quantum signature algorithms selected from ML-DSA, FN-DSA, and SLH-DSA, and wherein the continuous attestation chain remains unbroken across rotation between supported post-quantum primitives through use of hybrid signature envelopes binding legacy and rotated signatures into a single committed entry.

16. The platform of claim 1, wherein the audit-ready cryptographic evidence bundles are generated deterministically and on demand from the continuous attestation chain without requiring manual log correlation across heterogeneous systems, thereby reducing audit-evidence assembly time relative to manual cross-system log correlation approaches.

17. The method of claim 2, further comprising applying industry-specific smart-contract policies selected from the group consisting of healthcare, financial services, defense, and enterprise governance, each said policy specifying reward, slashing, and compliance gating rules.

18. The method of claim 2, further comprising automated reputation scoring that influences subsequent task allocation, reward weighting, and eligibility for high-value collaboration assignments, wherein reputation scores are non-transferable between agents and platform-level adjustment of reputation by smart-contract slashing is not treated as a transfer.

19. The method of claim 2, wherein the tokenized rewards are distributed using post-quantum-signed transactions employing one or more of ML-DSA, FN-DSA (Falcon), or SLH-DSA digital signature algorithms, optionally in a hybrid mode combining one or more classical signature algorithms and one or more post-quantum signature algorithms during a defined cryptographic transition period.

20. The method of claim 2, further comprising applying differential-privacy techniques to agent telemetry and aggregate collaboration data prior to publication or external audit, and applying cryptographic erasure of payload data referenced by ledger entries by deletion of decryption keys held in TEE-sealed storage in response to data-subject deletion requests, without modifying the integrity of the cryptographic links of the provenance ledger.
